(19) United States
(12) Patent Application Publication
(10) Pub. No.: US 2017/0145668 A1
(43) Pub. Date: May 25, 2017

(54) RESIDENTIAL FIRE SERVICE FIXTURE II

(71) Applicant: OW Investors, LLC (dba MARS Company), Ocala, FL (US)

(72) Inventors: Floyd Stanley Salser, Ocala, FL (US); Michael J Kebles, Las Vegas, NV (US)

(21) Appl. No.: 15/372,518

(22) Filed: Dec. 8, 2016

Related U.S. Application Data
(63) Continuation-in-part of application No. 12/263,606, filed on Nov. 3, 2008, now abandoned.
(60) Provisional application No. 60/984,782, filed on Nov. 2, 2007.

(51) Int. Cl. E03B 7/07; G01F 15/18; A62C 35/68; G01F 15/00

(52) U.S. Cl. CPC E03B 7/072; G01F 15/005; G01F 15/185; A62C 35/68

(57) ABSTRACT

The invention relates to an apparatus and method for providing a plurality of metered service lines to a residential utility system wherein one of the service lines may be independently disabled without affecting the other service lines.

### CLAIM TO PRIORITY

This application is a continuation in part to application Ser. No. 12/263,606, filed on 3 Nov. 2008 which claims priority to provisional application 60/984,782, filed on 2 Nov. 2007, which are incorporated herein by this reference for all that they disclose.

### TECHNICAL FIELD OF THE INVENTION

The present invention relates to an apparatus and method for allowing a utility provider to interrupt water service to a first residential service line while not interrupting such utility service to a second residential service line associated with such utility service where both first and second residential service lines are metered to monitor resource consumption.

### BACKGROUND

Utility companies are increasingly finding a need to provide two or more service lines for residential installations. One application in particular where a dual service line is needed in a residential environment relates to fire sprinkler systems. The world's first sprinkler system was installed in the United Kingdom in 1812. Sprinklers have been used in the United States since 1874 and such systems are required by many building codes. In addition, such sprinkler systems are becoming increasingly popular in residential applications. Insurance companies frequently offer reduced rates for residential homes equipped with fire suppression systems such as a sprinkler system.

There are many types of fire suppression systems including wet pipe systems, dry pipe systems, deluge systems, pre-action systems, and calm water sprinkler systems. Wet pipe systems are by far the most popular systems used in the residential environment. Such systems require at least two service lines to be provided from the utility meter to the residents. One service line provides the typical water supply to a residence while the second service line provides water to the fire sprinkler system.

A big problem with such prior art systems relates to the fire service line not being metered. Such is necessary in prior art systems because the water utility may wish to turn off the residential water supply without disabling the fire suppression system. Therefore, the supply line supplying water to the fire line service was necessarily connected to a point in front of the main water service shutoff valve. Unfortunately, in prior art systems, such shutoff valve is located at the input of the meter metering water consumption. There has been a long felt need for an apparatus that provides a plurality of metered service lines where one service line may be disabled while not disabling a second service line. The present invention addresses such need.

### SUMMARY

Objects and advantages of the invention will be set forth in the following description, or may be obvious from the description, or may be learned through practice of the invention.

Broadly speaking, a principal object of the present invention is to provide a residential utility service requiring a plurality of service lines with a plurality of metered utility service lines wherein such plurality of service lines may be independently enabled or disabled.

Another general object of the present invention is to provide an utility meter housing configured with at least one input suitable for associating a utility service line with a utility meter, and an output fixture comprising a fixture input and a plurality of fixture outputs wherein the fixture input is suitable for being associated with the output of a water meter and the fixture outputs are suitable for being associated with the service lines supplying a resource to a residence.

Yet another general object of the present invention is to provide a utility meter comprising an input and a plurality of outputs, wherein one output is configured with a shutoff valve.

Another general object of the invention is to provide a fixture comprising one input and a plurality of outputs where the flow through such outputs may be independently interrupted or enabled.

Additional embodiments of the present subject matter, not necessarily expressed in this summarized section, may include and incorporate various combinations of aspects of features or parts referenced in the summarized objectives above, and/or features or components as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is an elevated perspective view of one exemplary embodiment of the invention comprising a utility box configured with an output fixture;

FIG. 2 is an side elevated perspective view of one exemplary embodiment of the invention comprising a utility meter with a fluid chamber comprising one input and a plurality of outputs;

FIG. 3 is an elevated perspective view of a flow control fixture according to one exemplary embodiment of the invention;

FIG. 4 is a front side view of the flow control fixture depicted in FIG. 3;

FIG. 5 is a backside view of the flow control fixture depicted in FIG. 3;

FIG. 6 is a top view of the flow control fixture depicted in FIG. 3;

FIG. 7 is a partially exploded side view of the flow control fixture depicted in FIG. 3; and

FIG. 8 is a side perspective view of a unitized elbow with two outputs and an input.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only, and is not intended as limiting the broader aspects of the present invention.

It should be appreciated that this document contains headings. Such headings are simply place markers used for ease of reference to assist a reader and do not form part of this document or affect its construction.

For the purposes of this document, unless specifically stated otherwise, the phrase “at least one of A and B” means “at least one of A OR at least one of B or both” (not “at least one of A and at least one of B”).

For the purposes of this document two or more items are “mechanically associated” by bringing them together or into relationship with each other in any number of ways including a direct or indirect physical connection that may be releasable (snaps, rivets, screws, bolts, etc.) and/or movable (rotating, pivoting, oscillating, etc.)

Similarly, for the purposes of this document, two items are “electrically associated” by bringing them together or into relationship with each other in any number of ways. For example, methods of electrically associating two electronic items/components include: (a) a direct, indirect or inductive communication connection, and (b) a direct/indirect or inductive power connection. Additionally, while the drawings illustrate various components of the system connected by a single line, it will be appreciated that such lines represent one or more connections or cables as required for the embodiment of interest.

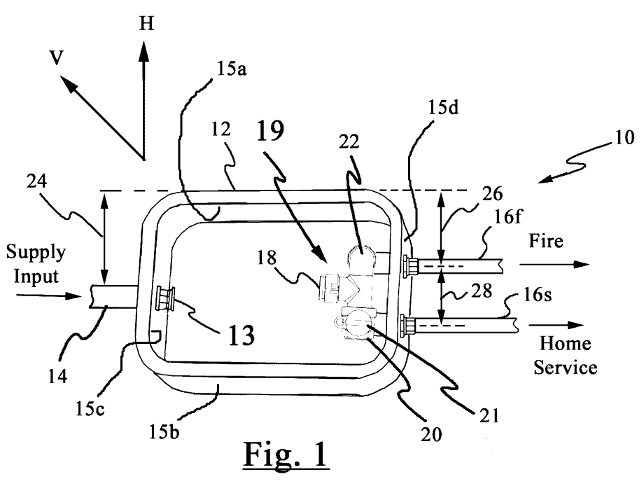

Referring now to FIG. 1, a residential utility meter enclosure (10) according to certain embodiments of the presently preferred invention is presented. Enclosure (10) is configured for receiving a typical residential utility meter configured for metering resource consumption, wherein the utility meter comprises one input and one output. Enclosure (10) defines a rectangular shape comprising two sets of opposed walls in one integral piece. It should be appreciated that enclosures defining any suitable shape and enclosures comprised of a plurality of components connected together to form such shape fall within the scope of the present invention. For the presently preferred embodiment enclosure 10 comprises a first wall 15c opposed by a second wall 15d wherein the first wall 15c defines a service input 13 and wherein the second wall 15d defines an plurality of enclosure outputs. Such plurality of enclosure outputs are shown associated with residential service line (16f) and residential service line (16s).

Enclosure 10 further comprises an output-fixture (19) defining a fixture-input (18), a first enclosure output and a second enclosure output. The first enclosure output is associated with residential service line 16s, and a second enclosure output is associated with residential service line 16f. Fixture-input (18) is preferably configured for being associated with the output of a typical residential utility meter. The first enclosure output and the second enclosure output are preferably associated with an output nut that is adjustable for different types of connections such as flared copper connections, compression connections, and iron pipe feting.

As shown FIG. 1, one end of service input 13 is associated with a utility service supply line 14 and the opposing end is configured for being associated with the input of a utility meter. For this embodiment of the invention, service input 13 is in substantial horizontal alignment (direction “H” as indicated in FIG. 1) with said fixture-input 18. Additionally, for the embodiment depicted in FIG. 1 service input 13 is in vertical alignment (direction “V” as indicated in FIG. 1) with fixture-input 18. Other configurations where the service input 13 is not in substantial alignment with the fixture-input 18 fall within the scope of the present invention.

Still referring to FIG. 1, the first enclosure output is associated with a flow control valve 21. For the presently preferred embodiment, flow control valve 21 is an angle ball valve although any suitable valve technology may be used. Flow control valve 21 is configured to control the flow of resources through said first fixture output without affecting the flow of resource through said second fixture output. One of ordinary skill in the art will appreciate that such a configuration allows the flow through the first fixture output to be disabled while still allowing flow through the second fixture output.

For one alternative embodiment, the second output 22 is configured with a flow control valve. Such a configuration allows the flow of resources to either fixture output to be interrupted independent of one another. Such a configuration is particularly useful for installations where only one output is presently needed but a need for a second output is anticipated in the future. Consequently, it should be appreciated that a residential utility meter enclosure according to embodiments of the present invention include configurations that have three or more outputs and a plurality of control valve configurations.

For the preferred embodiment of the residential utility meter enclosure 10, the metal components are composed of lead free waterworks brass or an engineered polymer resin or other suitable plastic material.

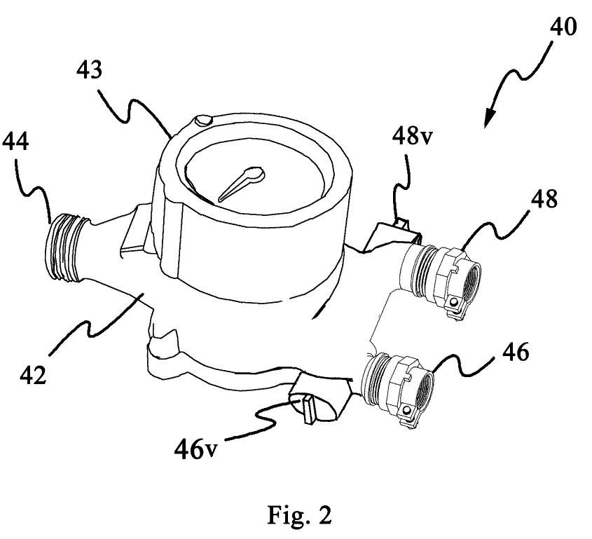

Referring now to FIG. 2, a residential utility meter (40) incorporating certain aspects of the present invention is now considered. Residential utility meter (40) comprises a fluid chamber (42) and a register (43) configured for metering the flow of water through a water system. For the presently preferred embodiment of the invention, fluid chamber (42) defines a flow detection section disposed between an input (44) and a plurality of outputs, said plurality of outputs comprising a first output (46) and second output (48). Fluid chamber 42 is configured so that water flows into said input (44), through said flow detection section and then to said first output and said second output.

A first cutoff valve (46v) is disposed between the first output (46) and said flow detection section. First cutoff valve (46v) is configured with a first state that allows the flow of water through the first output and a second state which prevents the flow of water through the first output. Similarly, a second cutoff valve (48v) is disposed between the second output (48) and said flow detection section and is configured with a first state that allows the flow of water through the second output (48) and a second state which prevents the flow of water through the second output (48). First cut off valve 46v the and second cutoff valve 48v are configured so that the water flow through the second output (48) is not dependent on the state of the first cutoff valve (46v) and the water flow through the first output (46) is not dependent on the state of the second cutoff valve (48v). One of ordinary skill in the art will appreciate that such a configuration allows resource flow through output 46 to be independent of the resource flow through output 48. Additionally, utility meter 40 may be used for meter installations currently requiring only one residential service line but an additional service line may be required in the future.

For the presently preferred embodiment, the first cutoff valve (46v) and the second cutoff valve (48v) are in horizontal alignment and vertical alignment with each other. Similarly, first output (46), and second output (48) are in alignment with each other. Additionally, the first cutoff valve (46v) is disposed adjacent to first output (46) and the second cutoff valve is disposed adjacent to second output (48). Such an embodiment for utility meter 40 allows the meter to be installed in a standard residential utility meter box having a single input and a dual output.

As described above for the residential utility meter box 10, the first cutoff valve and said second cutoff valve are angle ball valves comprising a lockable valve key (not depicted in FIG. 2). Similarly for the current embodiment, fluid chamber components may be constructed from water works brass, engineered polymer resins, or any suitable plastic material.

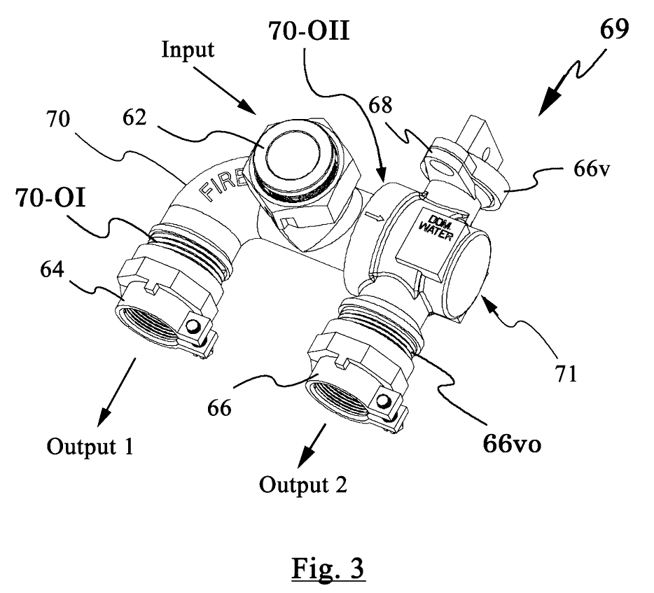

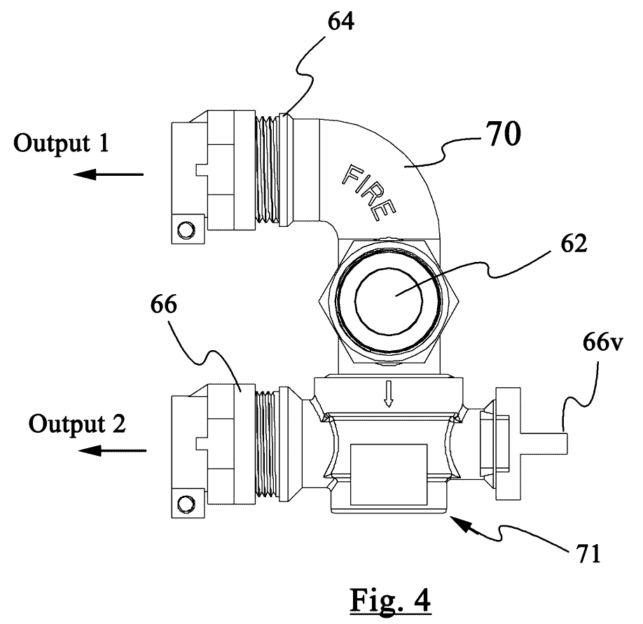

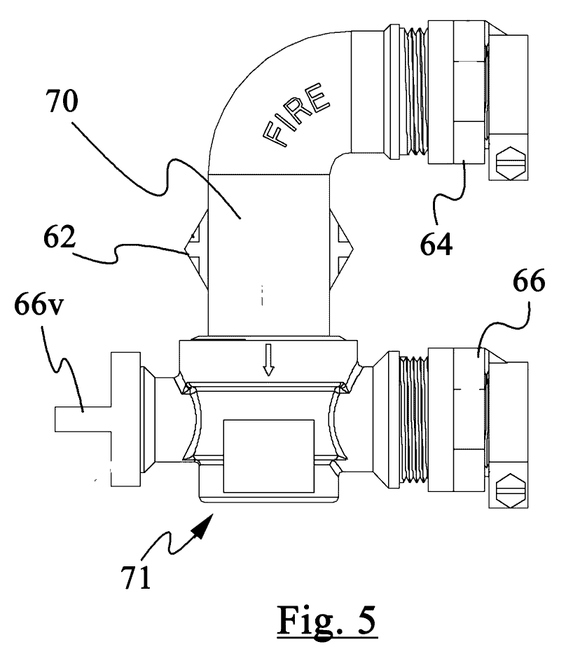

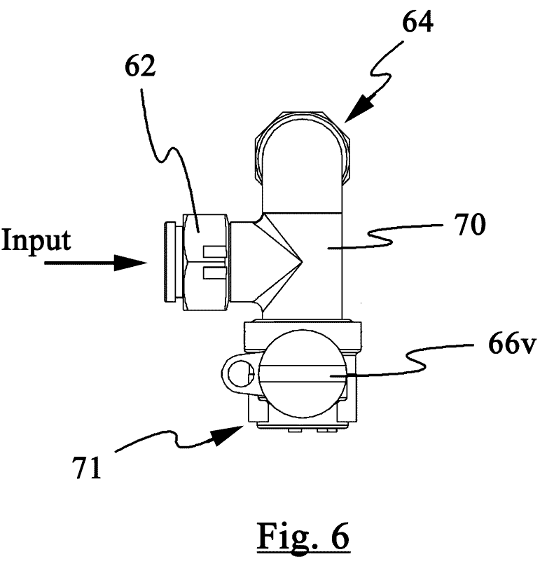

Referring now to FIG. 3, FIG. 4, FIG. 5, and FIG. 6, a flow control fixture 69 according to various aspects of the present invention is considered. Flow control fixture 69 is configured for being disposed between the output of a utility meter and the output of a utility meter box (for example) to control the flow there between. Flow control fixture 69 comprises a fixture body (70) defining a fixture input 62 suitably configured for being associated with the output of a utility meter. Fixture body (70) further defines first fixture body output (70-OI) and second fixture body output (70-OII), each in fluid communication with fixture input (62). As one of ordinary skill in the art will appreciate, for such presently preferred embodiment, flow control fixture 69 comprises one input (62) and two outputs, (output 1 and output 2). For such configuration, output 1 is the first fixture body output (70-OI) of fixture body (70) while output 2 is the valve output (66vo) of flow control valve (66v).

For some configurations, fixture output 1 and output 2 are associated with output coupling 64 and output coupling 66. For the presently preferred embodiment, flow control fixture 69 comprises two output couplings; fixture output coupling 64 and fixture output coupling 66. Fixture output couplings 64 and 66 are suitably configured for being associated with the resource supply lines of a residential supply system for a resource such as water. Fixture body 70 is disposed between fixture input 62 and the fixture output couplings and is suitably configured for directing the flow of resource from said fixture input to the fixture output 1 and output 2 (as depicted in FIG. 3).

Output 70-OII of fixture body 70 is suitably configured for being associated with a first flow control valve 66v which is disposed between fixture output coupling 66 and fixture input 62 at a first flow control point (71). Flow control point (71) is suitably positioned so that the first flow control valve 66v controls the flow of resource to output 2 without controlling the flow of resource to output 1. For one alternative embodiment, a second flow control valve is disposed between output (70-OI) and said fixture input 62 at a second flow control point. Such second flow control point is suitably positioned so that the second flow control valve controls the flow of resource to output 1 without controlling the flow of resource to output 2. As described above one or more flow control valves may be configured with a locking mechanism 68. For the preferred embodiment, locking mechanism 68 extends away from flow control valve 66v in the same direction of input (62) as depicted in FIG. 3. For the current configuration, locking mechanism 68 is a lockable valve key.

One of ordinary skill in the art will appreciate that the above teachings may be used to further include a main flow control valve disposed between said fixture input and all of the fixture outputs. For the embodiment depicted in FIG. 3, the flow control fixture comprises a fixture input, a fixture body, and fixture outputs that are substantially equal in size. For some embodiments, the size of the flow path through said fixture input and said fixture body are substantially equal but about 20% larger than the flow path through said plurality of fixture outputs. It should be appreciated that any suitable flow control fixture size configurations may be used without departing from the scope and spirit of the present invention.

As described above, the outputs of flow control fixture (69) define an adjustable connection that is adjustable to different types of connections including flared copper connections, compression connections, and iron pipe feting. Similarly, the fixture input of flow control fixture 69 preferably defines a meter coupling adaptable to a variety of meter sizes.

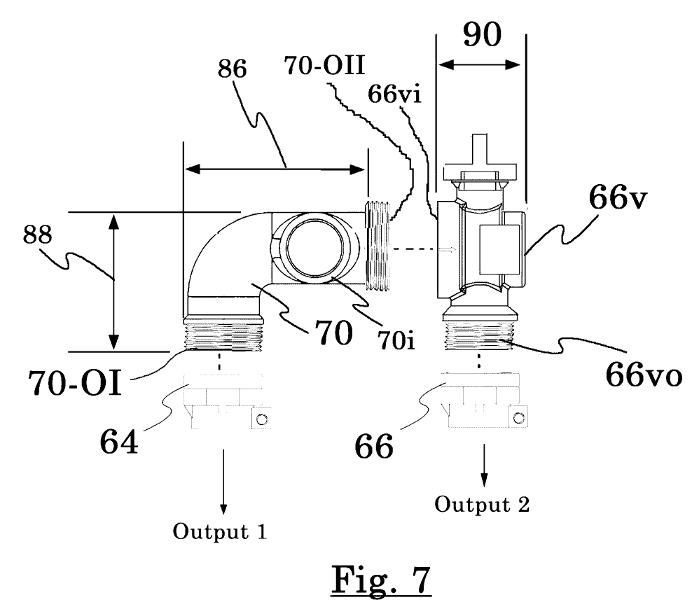

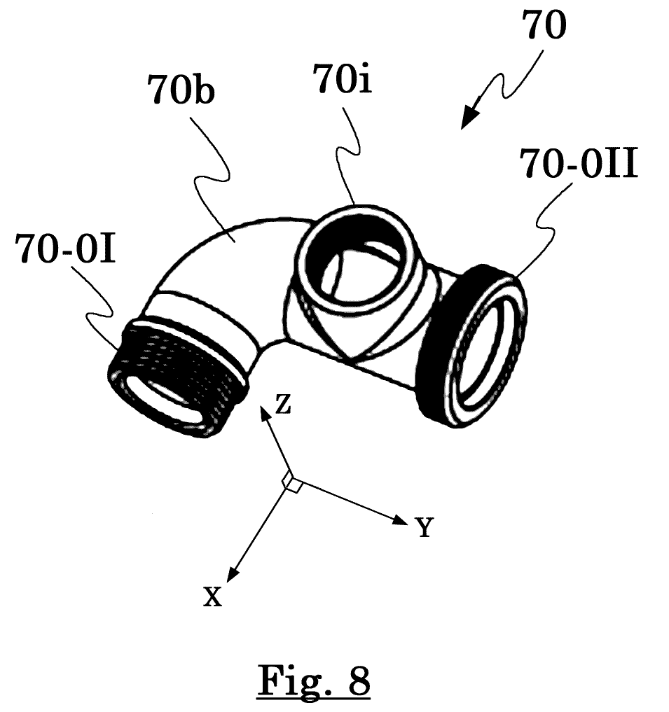

Referring now to FIG. 7 and FIG. 8, fixture body 70 is examined in more detail. FIG. 7 is a partially exploded side view of the flow control fixture depicted in FIG. 3 (without an input coupling) while FIG. 8 is a side perspective view of a unitized elbow with two outputs and an input. For this embodiment of the invention, the flow control fixture comprises a unitized body (70) comprising an input (70i), a first output (70-OI) and a second output (70-OII). For such embodiment, unitized body (70i) defines an elbow shape with first output (70-OI) at one end and second output (70-OII) at an opposing end so that the flow path through said outputs are perpendicular to each other but in the same flow plane (e.g. one flow path is in the “Y” direction and the other flow path is in the “X” direction in a three-dimensional coordinate system). Unitized body (70) further defines input (70i) disposed between first output (70-OI) and second output (70-OII) so that the flow path through input (70i) is perpendicular to the flow path through first output (70-OI) and second output (70-OII) and in a perpendicular flow path plane (e.g. the “Z” axis in a three-dimensional coordinate system; see FIG. 8).

As best seen in FIG. 7, second output (70-OII) is configured for being associated with valve input (66vi) of flow control valve (66v). The valve output (66vo) of flow control valve (66v) defines output 2 of flow control fixture (69) while first output (70-OI) of unitized body (70) defines output 1 of flow control fixture (69). Such a configuration minimizes the need for couplings thereby improving the overall pressure rating of flow control fixture (69).

It is well known in the art that for many now existing residential installation sites, a water meter is already installed in a common residential water meter box configured for being associated with a water meter having a single output. Such meter boxes may be as small as 6 inches (152.4 mm) wide and as wide as 12 inches (304.8 mm). Thus, for one preferred embodiment, the overall width of flow control fixture is between about 6.0 inches (152.4 mm) and 12 inches (304.8 mm) although larger sizes fall within the scope of the present invention. For the current embodiment, as shown in FIG. 7, the width (86) of unitized body (70) is about 100 mm (3.9 inches) and the width 90 of flow control vale 66v is 50.8 mm for an overall width of 150.8 mm (5.93 inches).

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be clear to one of ordinary skill in the art.

What is claimed is:

1. A residential utility meter for metering the flow of water through a residential water system, said utility meter comprising:
a fluid chamber defining a flow detection section disposed between an input and a plurality of outputs, said plurality of outputs comprising a first output and second output, said fluid chamber configured so that water flows into said input, through said flow detection section and then to said first output and said second output;
a first cutoff valve disposed between the first output and said flow detection section, wherein said first cutoff valve is configured with a first state that allows the flow of water through the first output and a second state which prevents the flow of water through the first output;
a second cutoff valve disposed between the second output and said flow detection section, wherein said second cutoff valve is configured with a first state that allows the flow of water through the second output and a second state which prevents the flow of water through the second output; and
wherein the water flow through the second output is not dependent on the state of the first cutoff valve.

2. A residential utility meter as in claim 1, wherein said utility meter is appropriately configured for being installed in a standard residential utility meter box.

3. A residential utility meter as in claim 1, further comprising a second cutoff valve disposed between the second output and said flow detection section, wherein said second cutoff valve is configured with a first state that allows the flow of water through the second output and a second state which prevents the flow of water through the second output and wherein the first cutoff valve and the second cutoff valve are in horizontal alignment with each other and were in the first cutoff valve is disposed adjacent to the first output and the second cutoff valve is disposed adjacent to the second output.

4. A residential utility meter as in claim 3, wherein said first cutoff valve and said second cutoff valve are angle ball valves comprising a lockable valve key.

5. A residential utility meter as in claim 1, wherein the input, the first output, and the second output are in alignment with each other.

6. A residential utility meter enclosure configured for receiving a utility meter configured for metering resource consumption, said residential utility meter box comprising:
an enclosure defining at least a first wall opposed by a second wall wherein the first wall defines a service input and wherein the second wall defines a plurality of enclosure outputs;
an output-fixture defining a fixture-input and a plurality of fixture-outputs, wherein said fixture-outputs are associated with said plurality of enclosure outputs;
wherein said service input is suitably configured for being associated with the input of a utility meter and wherein the fixture-input is suitably configured for being associated with the output of a utility meter;
wherein said plurality of fixture outputs includes a first output associated with a first flow control valve; and
wherein said first flow control valve is configured to control the flow of resources through said first output.

7. A residential utility meter enclosure as in claim 6, wherein said plurality of outputs further include a second output configured with a second flow control valve configured to control the flow of resource through said second output.

8. A residential utility meter enclosure as in claim 7, wherein said service input is in substantial vertical alignment with said fixture-input .

9. A residential utility meter enclosure as in claim 8, wherein one of (a) said service input and (b) said output fixture further comprises a main shutoff valve configured to control the flow of resource through all of said plurality of outputs.

10. A residential utility meter enclosure as in claim 9, wherein at least one control valve is configured with a locking mechanism.

11. A flow control fixture configured for controlling the flow of a resource, said flow control fixture comprising:
a fixture input suitably configured for being associated with the output of a utility meter;
a plurality of fixture outputs suitably configured for being associated with the resource supply lines of a residential resource supply system, said plurality of fixture outputs including a first fixture output and a second fixture output;
a fixture body disposed between said fixture input and said plurality of fixture outputs, said fixture body suitably configured for directing the flow of resource from said fixture input to said plurality of fixture outputs; and
a first flow control valve disposed between said first fixture output and said fixture input at a first flow control point suitably positioned so that said first flow control valve controls the flow of resource through said first fixture output without controlling the flow of resource through the second fixture output.

12. A flow control fixture as in claim 11, further comprising a second flow control valve disposed between said second fixture output and said fixture input at a second flow control point suitably positioned so that said second flow control valve controls the flow of resource through said second fixture output without controlling the flow of resource through said first fixture output.

13. A flow control fixture as in claim 12, further comprising a main flow control valve disposed between said fixture input and all of said plurality of fixture outputs at a main flow control point suitably positioned so that said main flow control valve controls the flow of resource through the flow control fixture.

14. A flow control fixture configured for controlling the flow of a fluid, said flow control fixture comprising:
a one piece elongated three-way elbow comprising an elbow-input disposed between a first elbow-output and a second elbow-output and defining a first fluid communication path with said first elbow-output and a second fluid communication path with said second-elbow output, wherein said elbow-input defines a flow control fixture input that is suitably configured for being associated with a fluid source;
wherein said first elbow-output is defined at one end of said elongated three-way elbow and said second elbow-output is defined at a second end of said elongated three-way elbow so that the fluid flow paths through said outputs are perpendicular to each other;
a flow control device comprising a flow control device input and a flow control device output wherein said flow control device input is associated with said second elbow-output;
wherein said first elbow-output defines a first fixture output;
wherein said flow control device output defines a second fixture output; and
wherein said flow control device is configurable in a first state that allows the flow of a fluid through said flow control device input and out said flow control device output and a second state that prevents the flow of said fluid through said flow control device.

15. A flow control fixture configured for controlling the flow of a fluid as in claim 14, wherein the fluid source is the output of a water meter metering the flow of water.

16. A flow control fixture configured for controlling the flow of a fluid as in claim 15, wherein said elbow-input is disposed between said first elbow-output and said second elbow-output so that the flow path through said elbow-input is perpendicular to the flow path through said first elbow-output and said second elbow-output and wherein the length of said first fluid communication path is longer than said second fluid communication path.

17. A flow control fixture configured for controlling the flow of a fluid as in claim 15, wherein the overall width of said flow control fixture is between about 150 mm and about 300 mm.

18. A flow control fixture configured for controlling the flow of a fluid as in claim 15, wherein the length of said first fluid communication path is at least one-third longer than the length of said second fluid communication path.

19. A flow control fixture configured for controlling the flow of a fluid as in claim 14, wherein said flow control fixture supports a working pressure of at least 300 pounds per square inch without water leaks.
